(19) United States
(12) Patent Application Publication
(10) Pub. No.: US 2018/0144621 A1
(43) Pub. Date: May 24, 2018

(54) MEASUREMENT DATA PROCESSING METHOD

(71) Applicant: NEC Corporation, Tokyo (JP)

(72) Inventors: Ichiro ARAI, Tokyo (JP); Yuta NAMIKI, Tokyo (JP)

(73) Assignee: NEC Corporation, Tokyo (JP)

(21) Appl. No.: 15/802,655

(22) Filed: Nov. 3, 2017

(30) Foreign Application Priority Data
Nov. 21, 2016 (JP) 2016-225674

(51) Int. Cl. G08G 1/01; G06Q 50/10; H04W 24/10

(52) U.S. Cl. CPC G08G 1/0116; G06Q 50/10; H04L 41/0803; G08G 1/0133; H04W 24/10

(57) ABSTRACT

An edge computer is connected to plural types of sensors each measuring a status of a monitoring target and to a server apparatus. The edge computer has an acquisition unit, a determination unit, and a compression unit. The acquisition unit regularly acquires a data set including a plurality of measurement data measured by the plural types of sensors. The determination unit previously holds dependencies between the measurement data measured by the plural types of sensors when the monitoring target is normal as reference dependencies. The determination unit, every time the data set is acquired, determines whether or not dependencies between the measurement data included by the data set match the reference dependencies. The compression unit compresses the data set to transmit the data set to the server apparatus on a basis of a result of the determination.

### INCORPORATION BY REFERENCE

This application is based upon and claims the benefit of priority from Japanese patent application No. 2016-225674, filed on Nov. 21, 2016, the disclosure of which is incorporated herein in its entirety by reference.

### TECHNICAL FIELD

The present invention relates to a measurement data processing method, an edge computer, a program, and a measurement data processing system.

### BACKGROUND ART

Various types of measurement data processing systems have been proposed. A measurement data processing system includes a plurality of devices each having a sensor measuring the status of a monitoring target, one or more edge computers collecting data measured by the sensors from the devices (measurement data), and a server apparatus collecting the measurement data from the edge computers through a network.

For example, in Patent Document 1, a measurement data processing system is proposed. The measurement data processing system is configured to transmit specified measurement data at a specified transmission timing to a server apparatus through a network from a gateway apparatus serving as an edge computer. According to the technique described in Patent Document 1 (a first related technique), the gateway apparatus temporarily accumulates measurement data collected from devices and, for example, when it becomes a fixed time defied as the transmission timing, transmits the measurement data defied by a transmission definition ID to the server apparatus via the network.

Further, in Patent Document 2, a measurement data processing system is proposed. The measurement data processing system is configured to reduce the capacity of transmission from an edge computer to a server apparatus. According to the technique described in Patent Document 2 (a second related technique), a terminal serving as the edge computer determines whether or not measurement data to be transmitted presently can be predicted from the same kind of measurement data transmitted in the past and avoids transmitting measurement data that can be predicted to the server apparatus, thereby reducing the capacity of transmission.

Further, in Patent Document 3, a technique relating to a gas heat pump type air conditioner is proposed. The air conditioner has an indoor unit and an outdoor unit, and the outdoor unit includes various types of sensors and a gas engine. The technique is, in the air conditioner, detecting a sign of an abnormality of equipment by regularly sampling operation data showing the operation status of the equipment and comparing the data with a reference level. According to the technique described in Patent Document 3 (a third related technique), an initial monitoring mode is performed first. The initial monitoring mode is to create a reference level to become the basis for determination of an equipment abnormality or the like by sampling operation data of equipment during a predetermined period after starting monitoring. Next, a usual monitoring mode is performed. The usual monitoring mode is to determine whether there is a sign of an equipment abnormality or the like by regularly sampling operation data of equipment and comparing the data with the reference level. In a case where it is determined in the usual monitoring mode that there is a sign of an equipment abnormality or the like, an intensive monitoring mode is performed next. The intensive monitoring mode is to, by sampling operation data at a higher sampling frequency and comparing the data with the reference level, determine again whether there is a sign of an equipment abnormality or the like.
Patent Document 1: Japanese Unexamined Patent Application Publication No. JP-A 2015-028742
Patent Document 2: Japanese Unexamined Patent Application Publication No. JP-A 2014-209311
Patent Document 3: Japanese Unexamined Patent Application Publication No. JP-A 2004-309015

In the first related technique described above, the gateway apparatus serving as an edge computer temporarily accumulates measurement data collected from the devices and, at the transmission timing, transmits all the measurement data to the server apparatus via the network. As a result, a load on the network increases. According to the second related technique, it is possible to reduce the amount of data transmitted to the server apparatus via the network from the terminal serving as an edge computer.

However, the second related technique is based on prediction, so that there is a fear of bringing a case where, due to a prediction error, it is determined by mistake that measurement data important for abnormality determination can be predicated through such measurement data cannot be predicted actually and the measurement data is left without being transmitted. Moreover, in the third related technique, the frequency of sampling of operation data is changed, so that a situation that measurement data important for abnormality determination is not sampled is invited. For example, assuming the sampling frequency in the usual monitoring mode is once every ten minutes, a sign of an abnormality arising and disappearing during a short period of ten minutes cannot be detected in the usual monitoring mode. The sampling frequency is higher in the intensive monitoring mode than in the usual monitoring mode, but the intensive monitoring mode is not executed unless a sign of an abnormality is not detected in the usual monitoring mode. Although such a problem is solved by increasing the sampling frequency in the usual monitoring mode, the amount of data increases instead.

### SUMMARY OF THE INVENTION

An object of the present invention is to provide a measurement data processing method which solves the abovementioned problem, namely, a problem that it is difficult to effectively reduce the amount of measurement data without missing measurement data important for abnormality determination.

A measurement data processing method as an aspect of the present invention is a measurement data processing method executed by an edge computer connected to plural types of sensors each measuring a status of a monitoring target and also connected to a server apparatus. The measurement data processing method includes: regularly acquiring a data set including a plurality of measurement data measured by the plural types of sensors; previously holding dependencies between the measurement data measured by the plural types of sensors when the monitoring target is normal as reference dependencies and, every time the data set is acquired, performing determination whether or not dependencies between the measurement data included by the data set match the reference dependencies; and performing compression of the data set to transmit the data set to the server apparatus on a basis of a result of the determination.

An edge computer as another aspect of the present invention is an edge computer connected to plural types of sensors each measuring a status of a monitoring target and also connected to a server apparatus. The edge computer includes: an acquisition unit configured to regularly acquire a data set including a plurality of measurement data measured by the plural types of sensors; a determination unit configured to previously hold dependencies between the measurement data measured by the plural types of sensors when the monitoring target is normal as reference dependencies and, every time the data set is acquired, perform determination whether or not dependencies between the measurement data included by the data set match the reference dependencies; and a compression unit configured to perform compression of the data set to transmit the data set to the server apparatus on a basis of a result of the determination.

A non-transitory computer-readable medium storing a program as another aspect of the present invention includes instructions for causing a computer, which is connected to plural types of sensors each measuring a status of a monitoring target and also connected to a server apparatus, to function as: an acquisition unit configured to regularly acquire a data set including a plurality of measurement data measured by the plural types of sensors; a determination unit configured to previously hold dependencies between the measurement data measured by the plural types of sensors when the monitoring target is normal as reference dependencies and, every time the data set is acquired, perform determination whether or not dependencies between the measurement data included by the data set match the reference dependencies; and a compression unit configured to perform compression of the data set to transmit the data set to the server apparatus on a basis of a result of the determination.

With the above configurations of the present invention, it is possible to effectively reduce the amount of measurement data without missing measurement data important for abnormality determination.

### BRIEF DESCRIPTION OF DRAWINGS

FIG. 1 is a block diagram of a measurement data processing system according to a first exemplary embodiment of the present invention;

FIG. 2 is a flowchart showing an example of an operation of an edge computer in the measurement data processing system according to the first exemplary embodiment of the present invention;

FIG. 3 is a flowchart showing an example of an operation of a server apparatus in the measurement data processing system according to the first exemplary embodiment of the present invention;

FIG. 4 is a block diagram showing a configuration of a second exemplary embodiment of the present invention;

FIG. 5 is a flowchart showing an example of an operation of the second exemplary embodiment of the present invention;

FIG. 6 is a diagram showing an example of measurement data collected at intervals of one second in a vehicle;

FIG. 7 is a diagram showing another example of measurement data collected at intervals of one second in a vehicle;

FIG. 8 is a diagram showing another example of measurement data collected at intervals of one second in a vehicle;

FIG. 9 is a block diagram showing a configuration of a third exemplary embodiment of the present invention;

FIG. 10 is a flowchart showing an example of an operation of the third exemplary embodiment of the present invention;

FIG. 11 is a block diagram showing a configuration of a fourth exemplary embodiment of the present invention;

FIG. 12 is a flowchart showing an example of an operation of the fourth exemplary embodiment of the present invention;

FIG. 13 is a block diagram showing a configuration of a fifth exemplary embodiment of the present invention;

FIG. 14 is a flowchart showing an example of an operation of the fifth exemplary embodiment of the present invention;

FIG. 15 is a block diagram of an information processing apparatus realizing an edge computer; and

FIG. 16 is a block diagram showing an information processing apparatus realizing a server apparatus.

### EXEMPLARY EMBODIMENT

Next, exemplary embodiments of the present invention will be described in detail with reference to the drawings.

### First Exemplary Embodiment

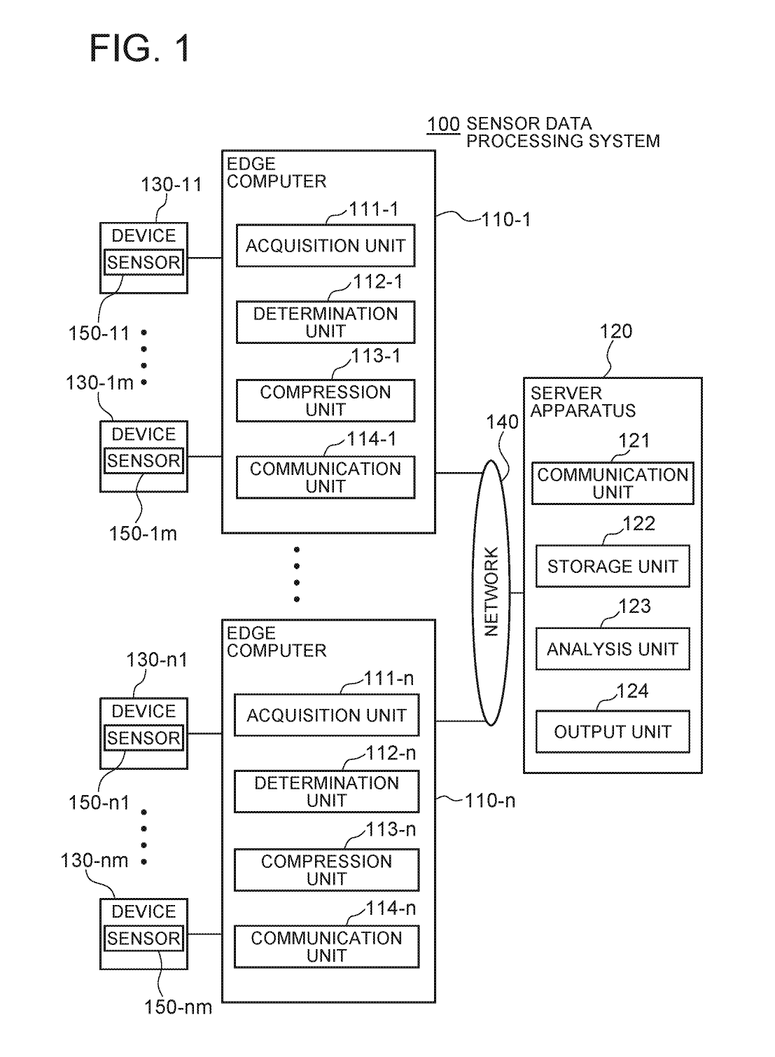

With reference to FIG. 1, a measurement data processing system 100 according to a first exemplary embodiment of the present invention includes a plurality of edge computers 110-1 to 110-n, a server apparatus 120, and a plurality of devices 130-11 to 130-nm. Each of the devices 130-11 to 130-nm includes at least one sensor denoted by reference numerals 150-11 to 150-nm. Each of the edge computers 110-1 to 110-n is connected to the server apparatus 120 via a network 140 such as a LAN, a mobile communication network and the Internet. In the following description, when there is no special reason for distinguishing members from each other, the members will be denoted by a reference numeral in which numbers and symbols following a hyphen are omitted; for example, the edge computers 110.

Each of the devices 130 includes at least one sensor 150. The sensor 150 senses a physical status of equipment, apparatus, system, soil, space, water and so on to be monitored by the measurement data processing system 100 (referred to as a monitoring target hereinafter). The sensor 150 includes, for example, a temperature sensor, a humidity sensor, a pressure sensor, a speed sensor, an acceleration sensor, a GPS sensor for detecting a position, or the like. The devices 130 transmit data sensed by the sensor 150 included thereby (measurement data) to the edge computer 110 connected therewith, autonomously or in response to a request by the edge computer 110 connected therewith.

To the edge computer 110, one or a plurality of devices 130 are connected so that plural types of sensors 150 are connected. For example, to one edge computer 110, two or more devices 130 each including one of the sensors 150 of different types from each other are connected. Otherwise, to one edge computer 110, one or more devices each including two or more types of sensors 150 are connected. For example, one of the m sensors 150-11 to 150-1m of the m devices 130-11 to 130-1m connected to the edge computer 110-1 is a temperature sensor, and another is a pressure sensor. Otherwise, one of the m sensors 150-n1 to 150-nm of the m devices 130-n1 to 130-nm connected to the edge computer 110-n is a sensor for measuring the acceleration of a vehicle, and another is a sensor for measuring the braking amount a vehicle.

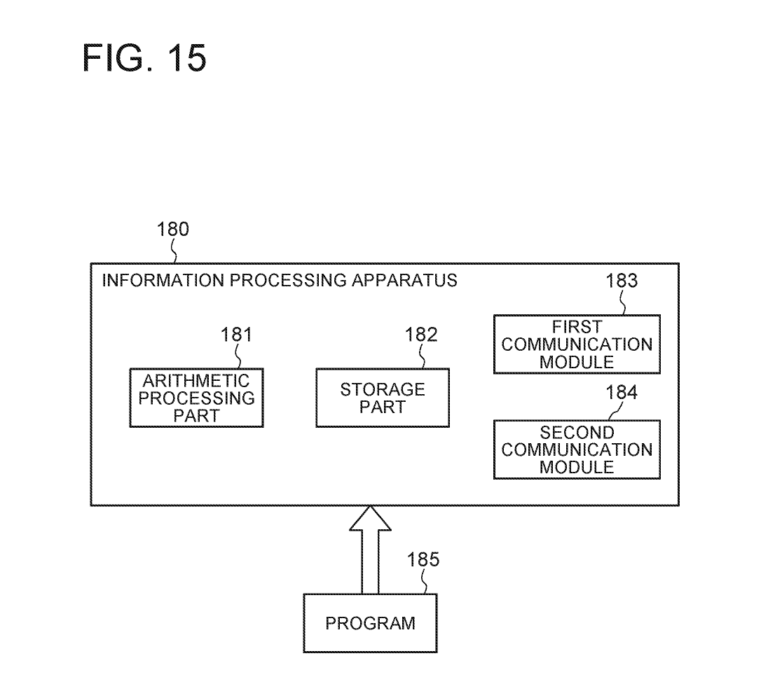

Further, each of the edge computers 110 includes an acquisition unit 111, a determination unit 112, a compression unit 113, and a communication unit 114. The units 111 to 114 can be realized by a computer configuring the edge computer 110 and a program. The program is provided in a state recorded on a computer-readable recording medium such as a semiconductor memory and a CD-ROM, and is read by the computer, for example, at the startup of the computer. Then, the program controls the operation of the computer, thereby realizing the acquisition unit 111, the determination unit 112, the compression unit 113 and the communication unit 114 on the computer. That is, for example, as shown in FIG. 15, the edge computer 110 can be realized by an information processing apparatus 180 and a program 185. The information processing apparatus 180 has one or more arithmetic processing parts 181 like microprocessors, a storage part 182 such as a memory and a hard disk, a first communication module 183, and a second communication module 184. The first communication module 183 is used for communication with the device 130, and the second communication module 184 is used for communication with the server apparatus 120. The first communication module 183 is a module which performs wireless communication by using a protocol such as Bluetooth™ and ZigBee™. The second communication module 184 is a module which performs wide area wireless communication employed in a mobile phone network or a PHS network, for example. The program 185 is loaded to the memory from an external computer-readable recording medium, for example, at the startup of the information processing apparatus 180. The program 185 controls the operation of the arithmetic processing part 181, thereby realizing units such as the acquisition unit 111, the determination unit 112, the compression unit 113 and the communication unit 114 on the arithmetic processing part 181.

The acquisition unit 111 has a function to acquire measurement data from the sensors 150 of the devices 130 connected to the edge computers 110. For example, the acquisition unit 111 acquires measurement data of the sensors 150 from the devices 130 at fixed intervals. Otherwise, the acquisition unit 111 acquires measurement data of the sensors 150 from the devices 130, for example, every time it is an exact hour. The acquisition unit 111 adds acquisition time (measurement time) and information of the acquisition source sensor 150 to the acquired measurement data, and temporarily stores the data into a storage device such as a memory incorporated in the edge computer 110. Information of the sensor 150 can be, for example, a sensor identifier.

The determination unit 112 has a function to determine whether or not dependencies between plural kinds of measurement data acquired by the acquisition unit 111 match dependencies established between plurality kinds of measurement data when a monitoring target is in the normal state (referred to as reference dependencies hereinafter). Dependencies between plurality kinds of measurement data are predetermined dependencies between plural kinds, for example, dependencies between measurement data of the acceleration sensor and measurement data of the sensor measuring the braking amount, and dependencies between measurement data of the temperature sensor and measurement data of the pressure sensor. The normal state is, in other words, an ordinary state, or a usual state, or a general state, or a steady state. Otherwise, the normal state refers to when there is no abnormality in a monitoring target. The reference dependencies can be dependencies decided by a method of machine learning such as invariant analysis, neural networks and deep learning on the basis of a large amount of measurement data in the past. Otherwise, the reference dependencies may be theoretically derived dependencies or experientially derived dependencies.

Further, in the abovementioned determination, the determination unit 112 separately considers a plurality of measurement data which match the reference dependencies as unimportant data and considers a plurality of measurement data which do not match the reference dependencies as important data. For example, the determination unit 112 considers a plurality of measurement data which do not match the reference dependencies as important data, and considers measurement data other than the important data as unimportant data. Otherwise, the determination unit 112 considers a plurality of measurement data which do not match the reference dependencies and measurement data acquired at near time as important data, and considers measurement data other than the important data as unimportant data. For example, it is assumed that there are three sensors of a temperature sensor, a pressure sensor and a humidity sensor and measurement data are acquired at time t1, time t2 and time t3. It is also assumed that dependencies between measurement data of the temperature sensor and measurement data of the pressure sensor acquired at time t2 of time t1, time t2 and time t3 do not match the reference dependencies. In this case, the determination unit 112 considers measurement data of the temperature sensor, the pressure sensor and the humidity sensor acquired at time t2 as important data, and considers measurement data of the temperature sensor, the pressure sensor and the humidity sensor acquired at time t1 and time t3 as unimportant data. Otherwise, the determination unit 112 considers, as important data, measurement data of the temperature sensor, the pressure sensor and the humidity sensor acquired at time t2, and measurement data of the temperature sensor, the pressure sensor and the humidity sensor acquired at time t1 and time t3 whose differences from the acquisition time t2 are within a predetermined time.

The compression unit 113 has a function to compress measurement data acquired by the acquisition unit 111 on the basis of the result of the determination by the determination unit 112. That is, the compression unit 113 does not compress important data, or compresses important data at a lower compression ratio than unimportant data. In other words, the compression unit 113 compresses unimportant data at a higher compression ratio than important data.

A plurality of methods of compression by the compression unit 113 can be conceived. In one method, the compression unit 113 compresses measurement data by removing part of the measurement data from the time series of the measurement data. For example, the compression unit 113 removes measurement data acquired at time t2 from time-series data composed of three measurement data acquired at time t1, time t2 and time t3 from a certain sensor 150, and converts the time-series data into time-series data composed the two measurement data acquired at time t1 and time t3. In another method, the compression unit 113 compresses measurement data by encoding the measurement data by high-efficiency encoding. For example, the compression unit 113 encodes the abovementioned time-series data composed of the three measurement data acquired at time t1, time t2 and time t3 by predictive encoding, gamma encoding, run-length encoding, or any high-efficiency encoding developed for measurement data.

The communication unit 114 has a function to transmit important data having not compressed or having compressed at a lower compression ratio than unimportant data by the compression unit 113 and the unimportant data having compressed at a higher compression ratio than the important data, to the server apparatus 120 via the network 140. The communication unit 114 discriminates and transmits important data and unimportant data. For example, the communication unit 114 may be configured to add a flag for the discrimination to the format of transmission data. Otherwise, the communication unit 114 may be configured to transmit important data and unimportant data by using communication protocols different from each other. For example, the communication unit 114 transmits important data by TCP communication, and transmits unimportant data by UDP communication. Otherwise, the communication unit 114 may be configured to transmit important data and unimportant data to the server apparatus 120 from the edge computer 110 through physically or logically different communication paths.

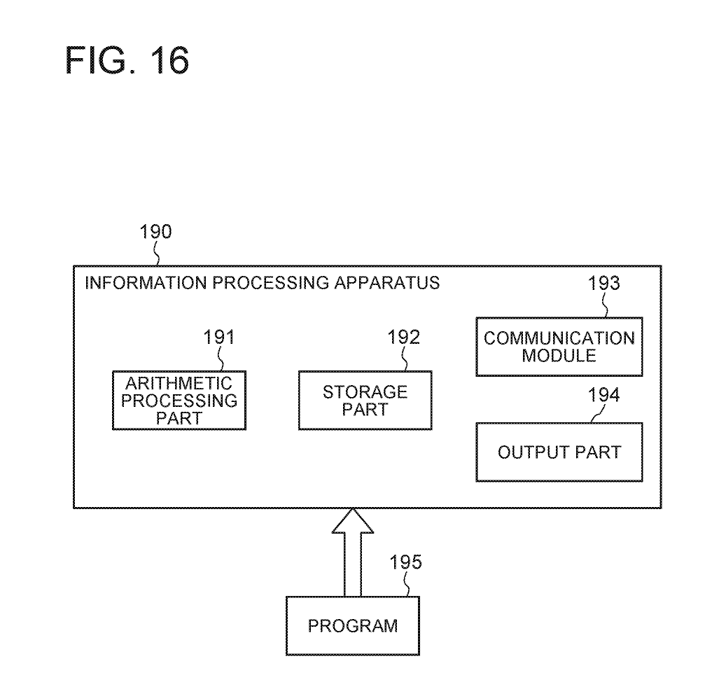

The server device 120 includes a communication unit 121, a storage unit 122, an analysis unit 123, and an output unit 124. These units 121 to 124 can be realized by a computer configuring the server apparatus 120 and a program. The program is provided in a state recorded on a computer-readable medium such as a semiconductor memory and a CD-ROM, and loaded to the computer, for example, at the startup of the computer. Then, the program controls the operation of the computer, thereby realizing the communication unit 121, the storage unit 122, the analysis unit 123, and the output unit 124 on the computer. That is, for example, as shown in FIG. 16, the server apparatus 120 can be realized by an information processing apparatus 190 including an arithmetic processing part 191 like one or more microprocessors, a storage part 192 such as a memory and a hard disk, a communication module 193 and an output part 194, and a program 195. The communication module 193 is used for communication with the edge computer 110. The communication module 193 is, for example, a module which performs wide area wireless communication employed by a mobile phone network or a PHS network. The output part 194 is, for example, a liquid crystal display, a printer, and so on. The program 195 is loaded to the memory from an external computer-readable recording medium at the startup of the information processing apparatus 190, and realizes units such as the communication unit 121, the storage unit 122, the analysis unit 123 and the output unit 124 on the arithmetic processing part 191.

The communication unit 121 has a function to receive measurement data from the edge computer 110 via the network 140 and stores the measurement data into the storage unit 122. The communication unit 121 receives important data and unimportant data discriminated from each other in accordance with a method for discrimination of important data from unimportant data by the communication unit 114, and stores the important data and the unimportant data into the storage unit 122 so that both the data are discriminated from each other.

The storage unit 122 has a function to store measurement data. The storage unit 122 can be configured with a single storage device. Otherwise, the storage unit 122 may be configured with a plurality of storage devices whose performances like reliability are different from each other; for example, two or more types of storage devices including a storage device for storing important data and a storage device for storing unimportant data.

The analysis unit 123 has a function to analyze measurement data stored in the storage unit 122 and detect the presence/absence of an abnormality of a monitoring target. In the storage unit 122, measurement data considered as important data and measurement data considered as unimportant data are stored. That is, in the storage unit 122, measurement data which are important data determined as including a sign of an abnormality on the edge computer side and measurement data which are unimportant data determined as including no sign of an abnormality on the edge computer side are stored. Therefore, the analysis unit 123 changes an analysis method on the basis of whether measurement data is important data or unimportant data. For example, in a case where measurement data are unimportant data, the analysis unit 123 omits a substantial analysis process on the measurement data and generates an analysis result representing that there is no sign of an abnormality in a monitoring target. On the other hand, for example, in a case where measurement data are important data, the analysis unit 123 analyzes the presence/absence of an abnormality and the cause of the abnormality on the basis of the measurement data, and generates an analysis result.

The output unit 124 outputs the result of the analysis by the analysis unit 123 to the server apparatus 120 through a local display apparatus or printer apparatus, or outputs the result to an external terminal apparatus by communication.

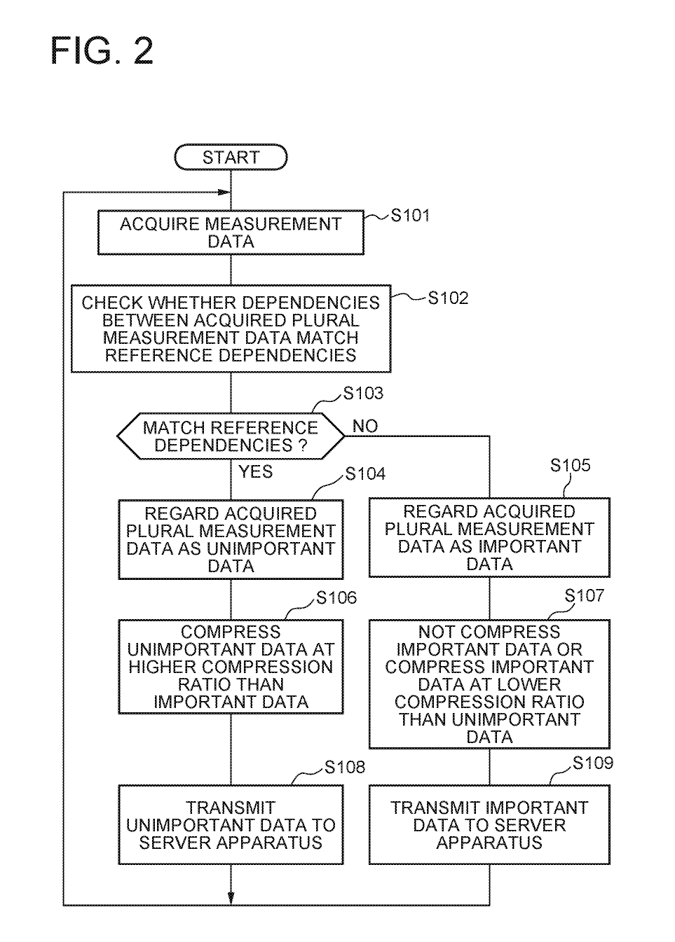

FIG. 2 is a flowchart showing an example of an operation of the edge computer 110. With reference to FIG. 2, the operation of the edge computer 110 will be described below.

In the edge computer 110, the acquisition unit 111 acquires measurement data from the sensors 150 of the devices 130 connected to the edge computer 110 (step S101). Next, the determination unit 112 determines whether dependencies between the plurality of measurement data acquired by the acquisition unit 111 match the reference dependencies (step S102). Next, in accordance with the determination result, the determination unit 112 separately considers the plurality of measurement data matching the reference dependencies as unimportant data and considers the plurality of measurement data that do not match the reference dependencies as important data (steps S103 to S105).

Next, the compression unit 113 compresses the unimportant data at a higher compression ratio than the important data (step S106). Moreover, the compression unit 113 does not compress the important data at all, or compresses the important data at a lower compression ratio than the unimportant data (step S107). Next, the communication unit 114 discriminates and transmits the important data and the unimportant data after processed by the compression unit 113 to the server apparatus 120 through the network 140 (steps S108 and S109).

In the edge computer 110, the process from step S101 to step S109 described above is repeatedly executed.

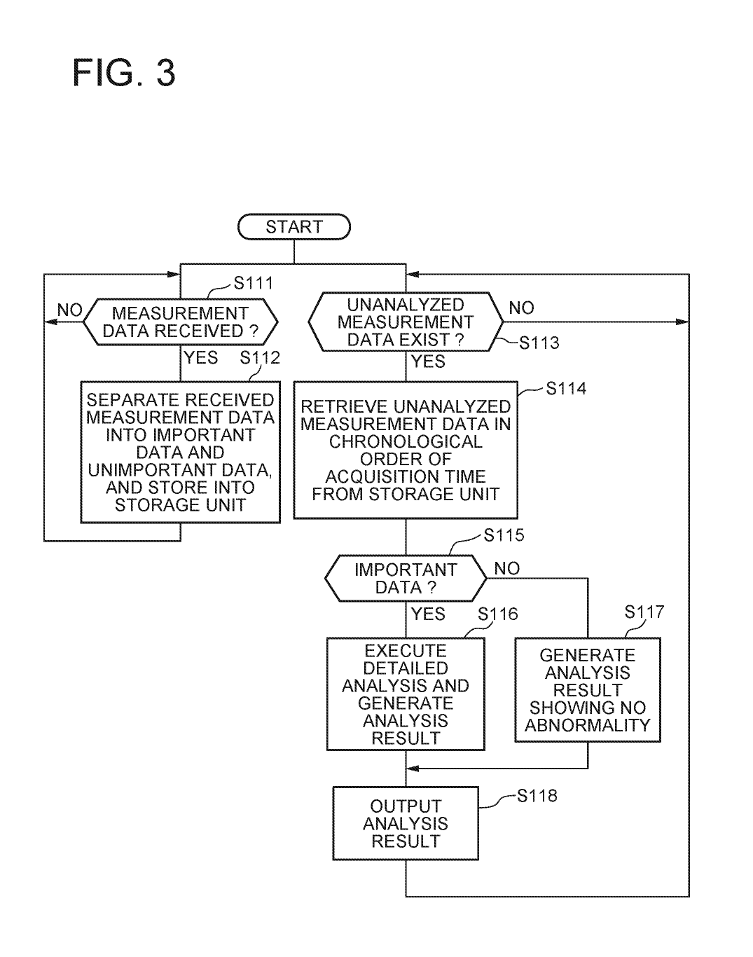

FIG. 3 is a flowchart showing an example of an operation of the server apparatus 120. With reference to FIG. 3, the operation of the server apparatus 120 will be described below.

In the server apparatus 120, the communication unit 121 determines whether it has received measurement data from the edge computer 110 (step S111). In the case of having received measurement data, the communication unit 121 separates the received measurement data into important data and unimportant data and stores into the storage unit 122 (step S112).

In parallel with the above operation, the analysis unit 123 determines whether unanalyzed measurement data is stored in the storage unit 122 (step S113). Next, in a case where unanalyzed measurement data is stored, the analysis unit 123 acquires the unanalyzed measurement data in chronological order of acquisition time (measurement time) from the storage unit 122 (S114). Next, the analysis unit 123 determines whether the acquired measurement data is important data or unimportant data (step S115).

Next, in a case where the acquired measurement data is important data, the analysis unit 123 executes a detailed analysis based on the important data and generates an analysis result (step S116). In the detailed analysis, the analysis unit 123 analyzes the presence/absence of an abnormality, the type and cause of the abnormality and so on, and generates a detailed analysis result. The detailed analysis result describes the presence/absence of an abnormality and, if an abnormality is detected, the cause of the abnormality, and also describes that the analysis result is based on the result of analysis of the important data.

On the other hand, in a case where the acquired measurement data is unimportant data, the analysis unit 123 generates a simple analysis result representing that there is no sign of an abnormality (step S117). The simple analysis result describes acquisition time of the measurement data contained in the unimportant data, and also describes that an abnormality has not occurred at the acquisition time and that this analysis result is based on the unimportant data.

Next, the output unit 124 outputs the analysis result generated by the analysis unit 123 (step S119).

In the server apparatus 120, the process from step S111 to S118 described above is repeatedly executed.

Thus, according to this exemplary embodiment, it is possible to effectively reduce the amount of measurement data without missing measurement data important for abnormality determination. This is because the acquisition unit 111 of the edge computer 110 acquires plural types of measurement data, the determination unit 112 determines whether dependencies between the plurality of measurement data having been acquired match the reference dependencies, which are dependencies established between types of measurement data in the normal state, and the compression unit 113 compresses the plurality of measurement data on the basis of the determination result. That is, measurement data in dependencies that do not match the dependencies established in the normal state are important data indicating a sign that an abnormality has occurred in a monitoring target, so that the measurement data are not compressed or are compressed at a lower compression ratio, and missing the measurement data is thereby prevented. On the other hand, measurement data in dependencies that match the dependencies established in the normal state do not indicate an abnormal sign, so that the measurement data are regarded as unimportant data and compressed at a higher compression ratio, and the amount of measurement data is thereby reduced.

Further, according to this exemplary embodiment, it is possible decrease a load necessary for analysis on the server apparatus executing abnormality determination. This is because the analysis unit 123 of the server apparatus 120 determines whether measurement data sent from the edge computer 110 are important data or unimportant data and, in a case where the measurement data is unimportant data, omits the detailed analysis and determines there is no abnormality. This utilizes a fact that the edge computer determines measurement data in dependencies matching the dependencies established in the normal state are unimportant data that do not indicate abnormal sign.

### Second Exemplary Embodiment

Next, a second exemplary embodiment of the present invention will be described. This exemplary embodiment changes the amount of measurement data to be thinned out in accordance with the degree of importance, both reducing the load on the network and the capacity of the storage and maintaining the data quality of measurement data are satisfied. Hereinafter, this exemplary embodiment will be described in detail.

### Background of this Exemplary Embodiment

In recent years, a keyword like IoT focuses attentions. In the IoT field, the following form is sometimes taken; gathering data collected from sensors once into an edge computer which is nearest the respective sensors, executing a process like thinning out the collected measurement data, and transmitting the data to a data store on a cloud. Thus, maintaining the data quality, reducing a network transfer load, and reducing the amount of data stored into the data store on the cloud are aimed. However, a processing rule and the like in this case need to be explicitly given by a system builder.

### Problem to be Solved in this Exemplary Embodiment

There is a case where, because of a load on the network and the performance of the data store (throughput, the capacity of the storage, and the like), collected measurement data need to be thinned out much. However, when the amount of measurement data to be thinned out is much, information in the middle slips away, and there is a possibility that it cannot be complemented within the range of errors required when measurement data are used (in this exemplary embodiment, it is considered that the data quality can be maintained when data in a required status can be obtained, whereas it is considered that the data quality cannot be maintained when data in a required status cannot be obtained). In order to prevent such a condition, there has been a need to explicitly set a rule in advance.

An object of this exemplary embodiment is to, without explicitly set a rule in advance, make it possible to reduce the data amount of measurement data transmitted to a data store of a cloud from an edge computer while maintaining the data quality.

### Solution by this Exemplary Embodiment

In this exemplary embodiment, a feature of invariant analysis “it is possible to detect a timing that a correlation between data collapses” is utilized, the amount of measurement data to be thinned out in accordance with the degree of importance is increased or decreased to reduce the amount of the entire measurement data, and reduction of a load on the network and loosening of the required performance of the data store are aimed.

By a machine learning method such as invariant analysis, neural networks and deep learning, leaning is performed on the basis of accumulated data to determine whether it is a steady state, data caused at a timing that it is not the steady state is considered as important, and the amount of measurement data to be thinned out is reduced.

### Configuration of this Exemplary Embodiment

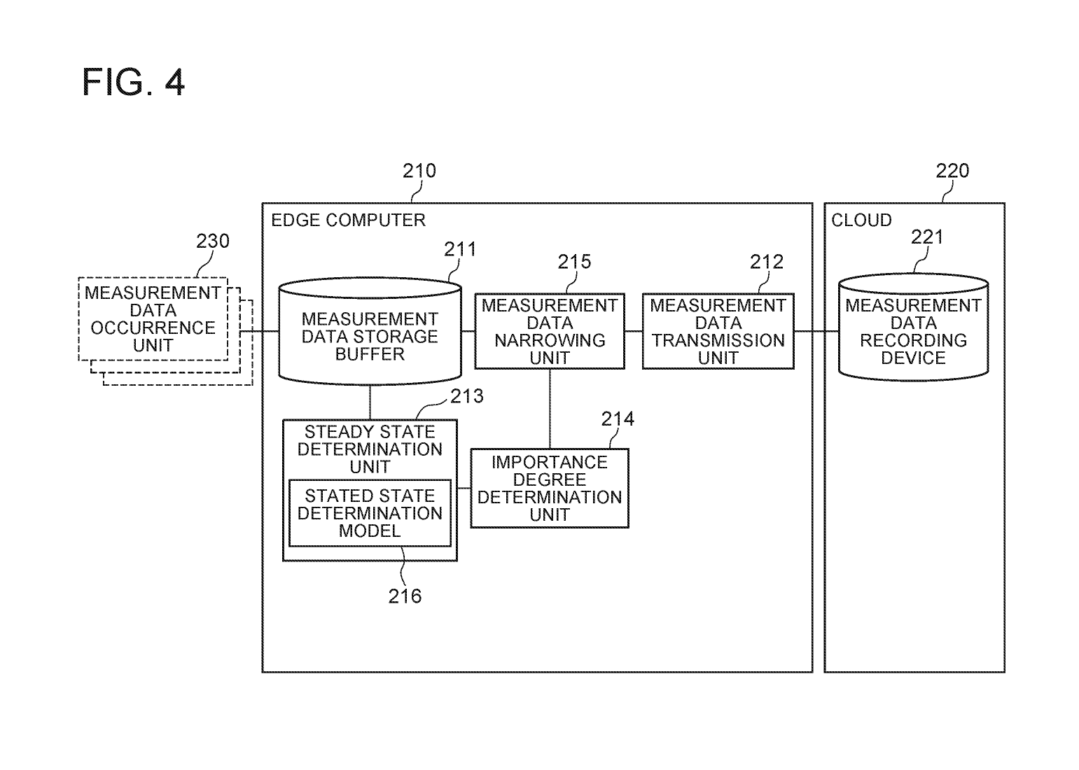

FIG. 4 is a block diagram showing a configuration of this exemplary embodiment. With reference to FIG. 4, a plurality of measurement data occurrence units 230 are connected to a single edge computer 210, and transmit measurement data to the edge computer 210. In the edge computer 210, the measurement data sent from the respective measurement data occurrence units 230 are stored into a measurement data storage buffer 211.

The edge computer 210 is connected through a measurement data transmission unit 212 to a measurement data recording device (a data store) 221 on a cloud 220, and can transmit and record measurement data.

The edge computer 210 further includes a steady state determination unit 213, an importance degree determination unit 214, and a measurement data narrowing unit 215.

The steady state determination unit 213 includes a steady state determination model 216. The steady state determination model 216 is obtained by learning a steady state by using a machine learning technique such as invariant analysis, neural networks and deep learning.

The importance degree determination unit 214 determines the degree of importance on the basis of determination by the steady state determination unit 213. In a case where the steady state determination unit 213 determines it is the steady state, the importance degree determination unit 214 determines as unimportant. On the contrary, in a case where the steady state determination unit 213 determines it is not the steady state, the importance degree determination unit 214 determines as important. A threshold for steady state determination is previously set.

The measurement data narrowing unit 215 thins out measurement data to be transmitted, and increases or decreases the amount of thinning out in accordance with the degree of importance. The measurement data narrowing unit 215 decreases the amount of thinning out in a case where the importance degree determination unit 214 determines as important, whereas increases the amount of thinning out much in a case where the importance degree determination unit 214 determines as unimportant. The amount of thinning out is based on the setting. Meanwhile, the measurement data narrowing unit 215 may continuously vary the amount of thinning out in accordance with the degree of importance.

The plurality of measurement data occurrence units 230 are connected to the single edge computer 210. FIG. 4 illustrates only one edge computer 210, but in general, a plurality of edge computers 210 are connected to the measurement data recording device 221.

### Operation of this Exemplary Embodiment

The steady state determination model 216 included by the steady state determination unit 213 is obtained by learning with the use of data in the steady state by using a machine learning method such as invariant analysis. By a machine learning method such as neural networks and deep learning other than invariant analysis, it may be determined whether measurement data having occurred (and a group of measurement data) are data in the steady state.

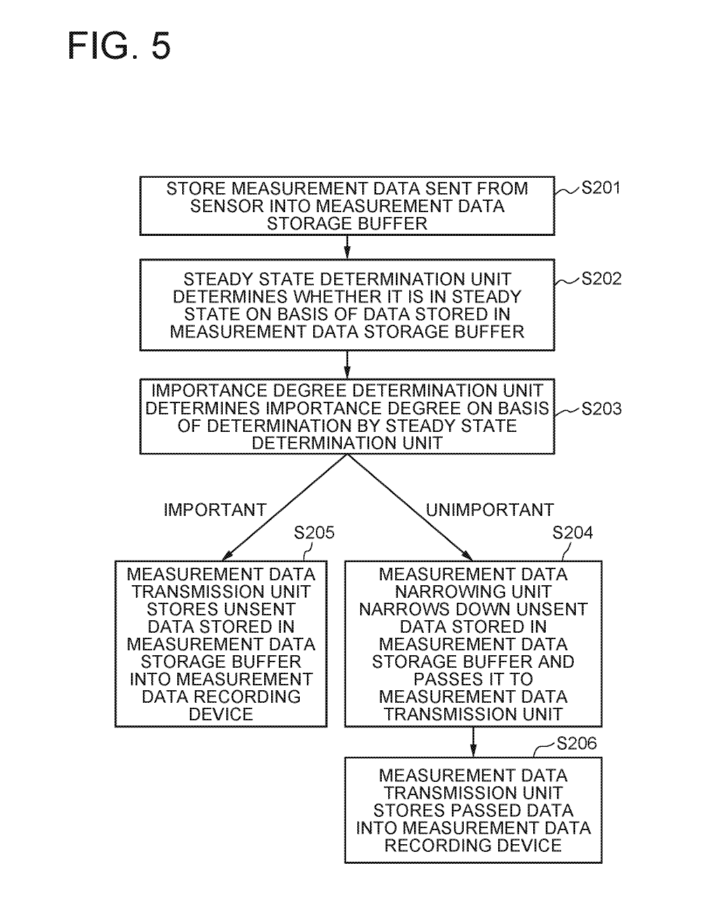

FIG. 5 is a flowchart showing an example of an operation of this exemplary embodiment. With reference to FIG. 5, the operation will be described below.

The edge computer 210 stores measurement data sent from the measurement data occurrence unit 230 into the measurement data storage buffer 211 (step S201). Hereinafter, an operation to store the measurement data into the measurement data recording device 221 serving as a measurement data perpetuating data store on the cloud 220 will be described.

In a case where measurement data stored in the measurement data storage buffer 211 are not important, it is desired to transmit the measurement data after thinning out much. On the other hand, in a case where the measurement data are not data in the steady state, it is regarded as a timing that an important event has occurred, so that it is desired to decrease the amount of the collected measurement data to be thinned out.

For example, when an experiment to find the Higgs boson or the like succeeds, different data from those in failed experiments in the past (the type of a boson, the track of each boson, energy, and so on) and a correlation between the data must be detected. By decreasing the amount of thinning out and collecting measurement data at a timing that a correlation between data measured by the sensors is different from a previous one, it is possible to collect data of an important part and concerning data before and after the important part with fine granularity while controlling a total data amount (and a network transfer amount).

The steady state determination unit 213 determines whether or not it is in the steady state on the basis of the data stored in the measurement data storage buffer 211 (step S202) and, on the basis of the determination, the importance degree determination unit 214 determines the degree of importance (step S203).

In a case where the importance degree determination unit 214 determines as unimportant, the measurement data narrowing unit 215 narrows down much unsent data stored in the measurement data storage buffer 211 and thereafter passes the data to the measurement data transmission unit 212 (step S204).

In a case where the importance degree determination unit 214 determines as important, the measurement data narrowing unit 215 decreases the amount of narrowing down unsent data stored in the measurement data storage buffer 211 and then passes the data to the measurement data transmission unit 212 (step S205).

The measurement data transmission unit 212 stores the passed data into the measurement data recording device 221 (step S206).

Hereinafter, the operation of this exemplary embodiment will be described in more detail with a specific example of the measurement data.

### Operation Example

For example, given the analysis of the cause of deterioration or failure of an engine with the use of data sent from a vehicular sensor, it is possible by using the apparatus of this exemplary embodiment to decrease measurement data and execute the analysis of the cause of deterioration or failure without influencing the analysis.

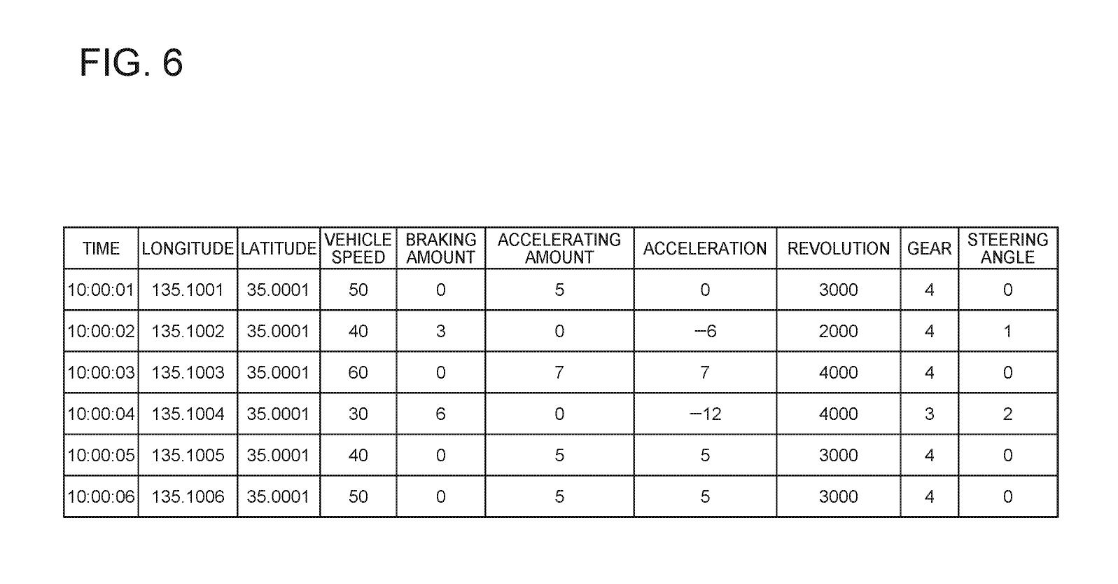

FIG. 6 shows an example of measurement data collected at intervals of one second in a vehicle, and each row shows a set of measurement data measured at the same time. For example, a set of measurement data on the second row shows that measurement time is 10:00:01, the vehicle is located at 135.1001 degrees longitude and 35.0001 latitude, the vehicle speed is 50 km/h, the braking amount is 0, the accelerating amount is 5, the acceleration of the vehicle is 0, the revolution of the engine is 3000 rpm, the gear position in the transmission is 4, and the steering angle of the steering wheel is 0. The measurement data shown in FIG. 6 is an example that any characteristic event has not occurred. Such a sequence of measurement data in the steady state can be obtained by measuring, for example, during test driving or safe driving. It is assumed that, from the measurement data of the vehicle as shown in FIG. 6, the steady state determination unit 213 has obtained a model as shown below by machine learning:

Acceleration=2×braking amount(where acceleration<0) (1)

The above model is a simplified one because it is an example. For example, by a method such as invariant analysis, various other correlations between sensors can be obtained as models. Otherwise, it is also possible to obtain by learning by selecting high correlations from various attributes by simple linear regression with acceleration as training data.

Thus, the steady state determination unit 213 acquires measurement data in a predetermined time period in which a monitoring target is in the steady state, and creates a relational model established between types of measurement data in the normal state. Meanwhile, a relational model may be created by a computer other than the edge computer 210 and set as the steady state determination model 216 into the edge computer 210.

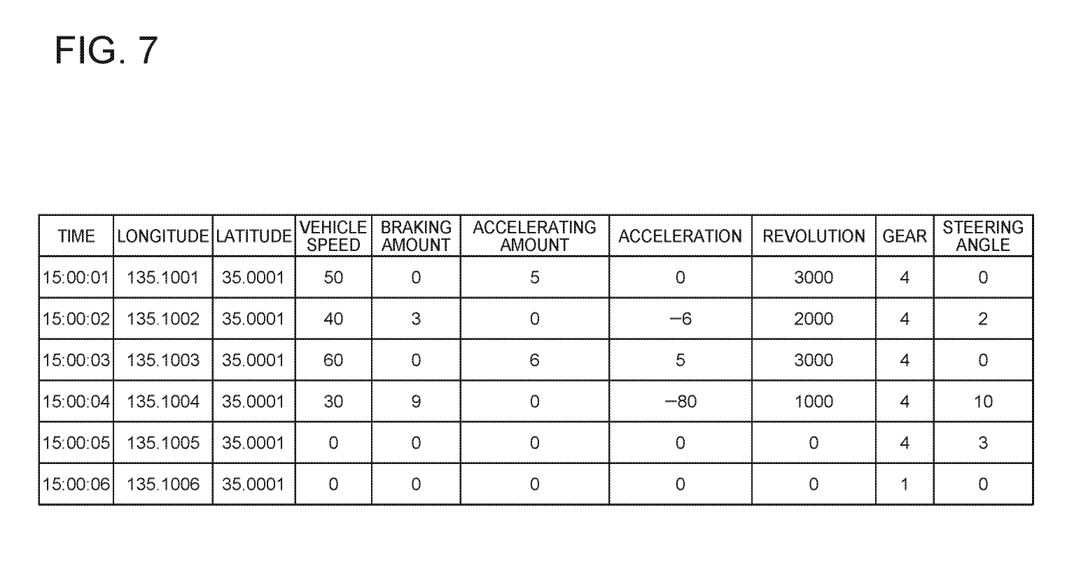

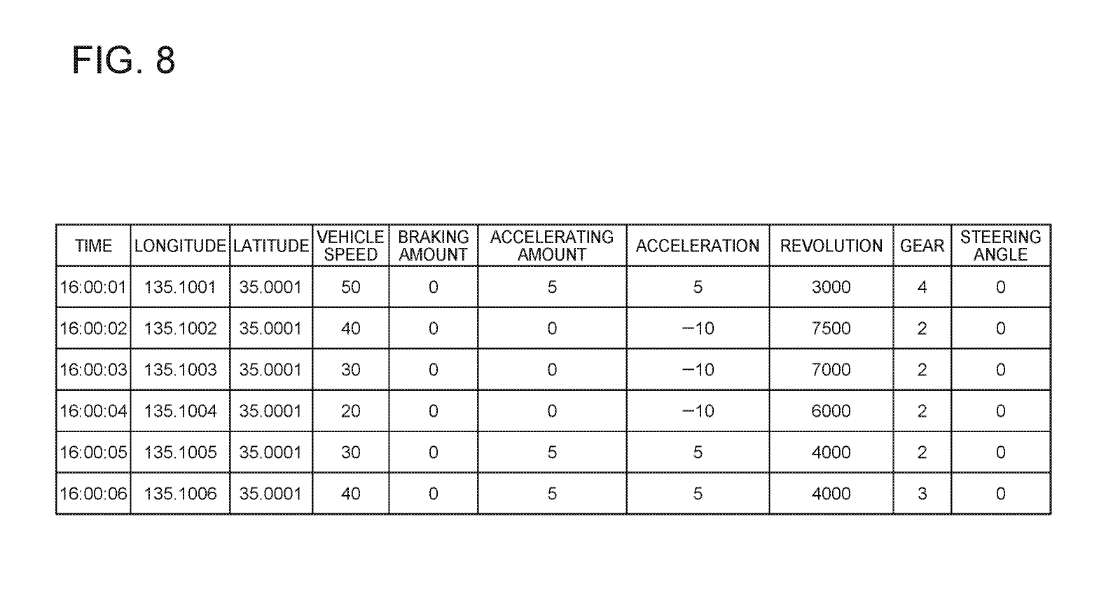

FIGS. 7 and 8 show other examples of measurement data collected every second in the vehicle. For example, assuming collected measurement data are transmitted after thinned out to every five seconds at all times, data of time 15:00:01 and data of time 15:00:06 are transmitted in the example of FIG. 7, and data of time 16:00:01 and data of time 16:00:06 are transmitted in the example of FIG. 8. Because data from time 15:00:02 to time 15:00:05 in FIG. 7 and data from time 16:00:02 to time 16:00:05 in FIG. 8 are not transmitted, if any event has occurred during the time period, it cannot be detected from outside.

Then, it is assumed that a characteristic event has occurred actually. In a set of measurement data at time 15:00:04 in FIG. 7, the acceleration is −80 and the braking amount is 9, which do not match the abovementioned model. That is, the correlation of the abovementioned model is collapsed. In the apparatus of this exemplary embodiment, measurement data at and around the measurement time 15:00:04 of the measurement data that do not match the model (a range of around the measurement time depends on the setting) are regarded as important data and transmitted without being thinned out. Consequently, the external server apparatus can analyze the measurement data sent thereto and infer occurrence of a collision like an accident on the basis of a high negative acceleration, the magnitude of the steering angle, and the magnitude of the braking amount.

Further, in a case where engine trouble occurs after that, the server apparatus can infer that the cause of the engine trouble is the collision. If simply transmitting data every five seconds, it is impossible to distinguish the event from stoppage by the brake. That is, it is difficult to infer the cause only from measurement data after thinned out.

Because the example shown in FIG. 7 has a characteristic in acceleration, it is possible to, for example, set a threshold and thereby include the data into transmission target data. That is, for example, if the threshold of an acceleration is set to −20, the data at time 15:00:04 in FIG. 7 shows an acceleration −80 and therefore can be included into transmission target data.

Below, an example that the event is missed even if a threshold is set will be described with reference to FIG. 8.

With reference to FIG. 8, the correlation of the abovementioned model is collapsed in measurement data from time 16:00:02 to time 16:00:04. The acceleration is not so large in magnitude and is lower than the threshold −20. In the apparatus of this exemplary embodiment, measurement data at and around the measurement time 16:00:02 to 16:00:04 of the measurement data that do not match the model (a range around the measurement time depends on the setting) are regarded as important data and transmitted without being thinned out. Thus, the external server apparatus can find that the engine is overloaded due to inappropriate shift down, on the basis of the measurement data transmitted thereto and a fact that the acceleration is minus though the braking amount is 0, the gear is changed from fourth into second while third is skipped and the revolution of the engine sharply rises (assuming it can be specified that the vehicle has not been on a slope or the like based on location information). If deterioration of the engine is severe only in such an ordinarily overloaded vehicle, it is possible to specify as the cause.

By frequently sending characteristic data (without gathering as statistic values) as in these examples, it is possible to use together with other data and check occurrence tendency in detail.

### Effect of this Exemplary Embodiment

According to this exemplary embodiment, it is possible to reduce the data amount of measurement data transmitted from the edge computer to the data store on the cloud as the quality of data is maintained.

Consequently, it is possible to decrease the load on the network and lower the specs (throughput, storage capacity, and so on) required by the recording device (the data store on the cloud). Moreover, it is possible to process data while focusing data deeply interested in. Moreover, it is also possible to collect unimportant data with rough granularity. Moreover, regarding either measurement data in scientific experiment facilities or measurement data of vehicular equipment, it is enough to perform machine learning with the use of data in the steady state in the past, and it is possible to easily obtain a model for determining the degree of importance (the steady state determination model).

### Third Exemplary Embodiment

Next, a third exemplary embodiment of the present invention will be described.

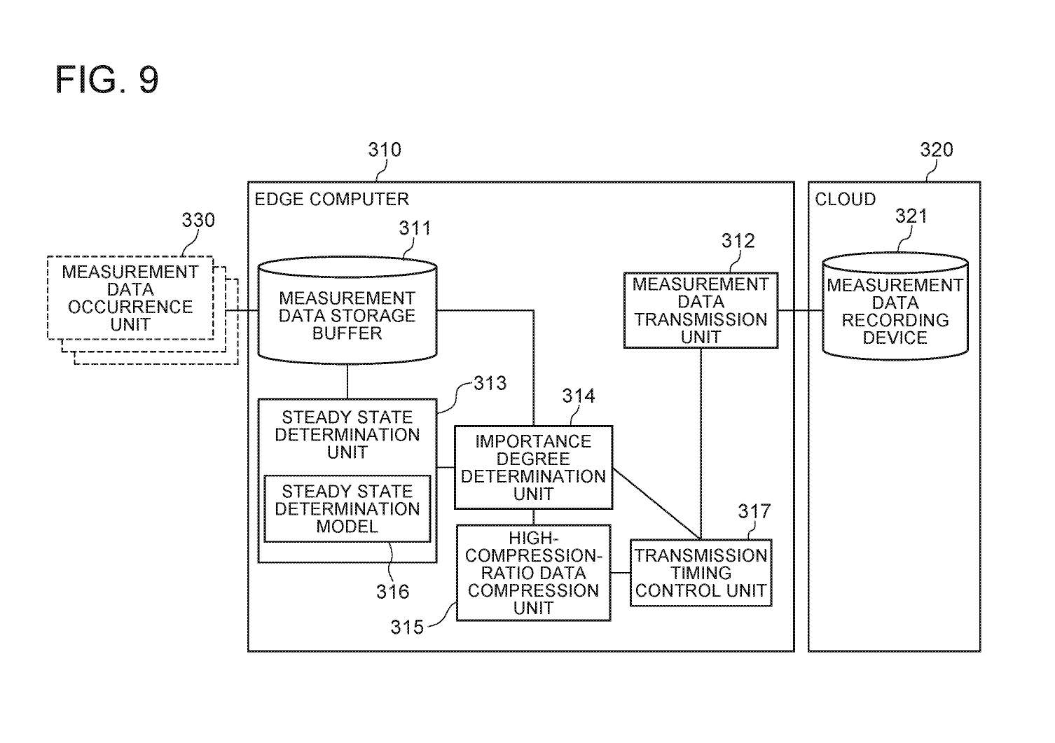

FIG. 9 is a block diagram showing a configuration of this exemplary embodiment. With reference to FIG. 9, this exemplary embodiment includes an edge computer 310 connected to a measurement data recording device 321 of a cloud 320, and a plurality of measurement data occurrence units 330 connected to the edge computer 310. The measurement data recording device 321 of the cloud 320 and the measurement data occurrence unit 330 have the same functions as the measurement data recording device 221 of the cloud 220 and the measurement data occurrence unit 230 shown in FIG. 4, respectively. The edge computer 310 includes a measurement data storage buffer 311, a measurement data transmission unit 312, a steady state determination unit 313, a high-compression-ratio data compression unit 315, a steady state determination model 316, and a transmission timing control unit 317. Of these units, the measurement data storage buffer 311, the measurement data transmission unit 312, the steady state determination unit 313 and the steady state determination model 316 have the same functions as the measurement data storage buffer 211, the measurement data transmission unit 212, the steady state determination unit 213 and the steady state determination model 216 shown in FIG. 4, respectively.

The transmission timing control unit 317 controls a timing for transmitting measurement data. The high-compression-ratio data compression unit 315 compresses data through a compression process at a high compression ratio though it takes time.

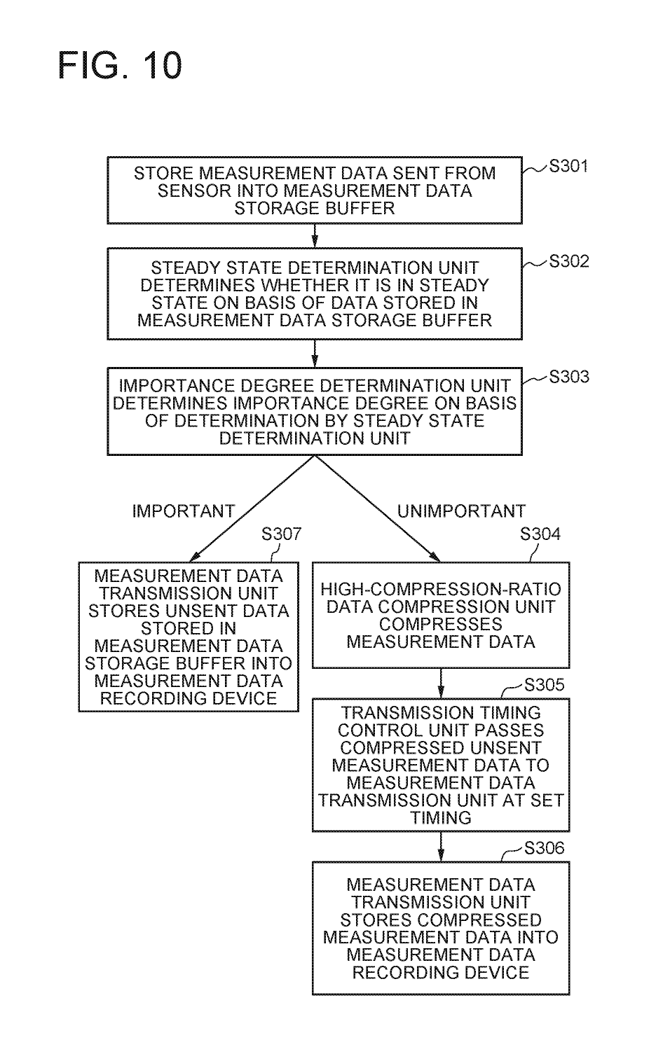

FIG. 10 is a flowchart showing an example of an operation of this exemplary embodiment. In FIG. 10, steps S301 to S303 are the same as steps S201 to S202 in FIG. 5. In this exemplary embodiment, in a case where the importance degree determination unit 314 does not determine as important, measurement data is not transmitted instantly. The transmission timing control unit 317 controls a timing for transmitting measurement data. For example, the transmission timing control unit 317 transmits measurement data stored in the measurement data storage buffer 311 after measurement data are once accumulated to some extent or at a previously set timing (for example, at regular intervals). In transmission, the high-compression-ratio data compression unit 315 compresses the measurement data at a high compression ratio over time (step S304). Then, at the previously set timing, the transmission timing control unit 317 passes unsent measurement data having been compressed to the measurement data transmission unit 312 (step S305). After that, the measurement data is stored into the measurement data recording device 321 by the measurement data transmission unit 312 (step S306).

On the other hand, in a case where the importance degree determination unit 314 determines as important, the transmission timing control unit 317 controls the transmitting timing so as to transmit instantly. Consequently, the measurement data transmission unit 312 transmits unsent transmission target data stored in the measurement data storage buffer 311, and stores it into the measurement data recording device 321 (step S307). The measurement data transmitted at this time may be uncompressed data or may be data subjected to simple compression (compression at a low compression ratio).

The steady state determination model 316 is a model obtained by learning with the use of measurement data in the steady state as described above.

Thus, the steady state is learned by machine learning, it is assumed that important data has occurred at a timing not in the steady state, and measurement data is transmitted instantly. Consequently, important data can be transmitted immediately (before lost) and used on the cloud. On the other hand, regarding unimportant data, by making a compression ratio higher and decreasing the frequency of transmission, it is possible to improve the efficiency of use of the network.

### Fourth Exemplary Embodiment

Next, a fourth exemplary embodiment of the present invention will be described.

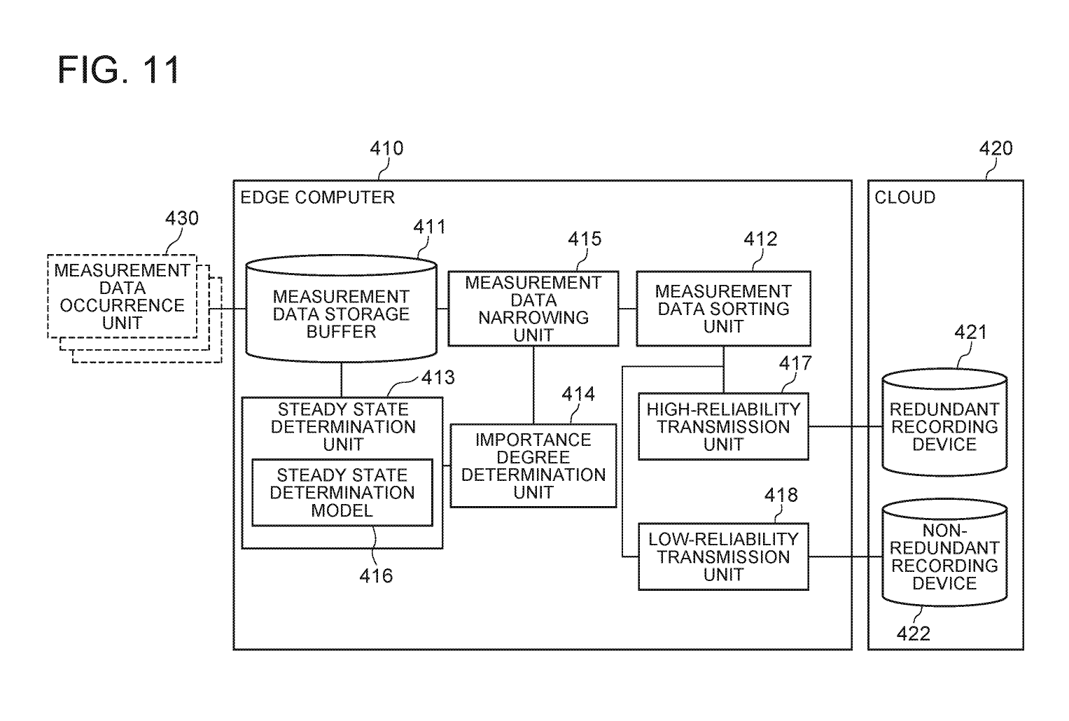

FIG. 11 is a block diagram showing a configuration of this exemplary embodiment. With reference to FIG. 11, this exemplary embodiment includes an edge computer 410 connected to a cloud 420, and a plurality of measurement data occurrence units 430 connected to the edge computer 410. The measurement data occurrence unit 430 has the same function as the measurement data occurrence unit 230 shown in FIG. 4. The cloud 420 includes a redundant recording device 421 and a non-redundant recording device 422. The edge computer 410 includes a measurement data storage buffer 411, a measurement data sorting unit 412, a steady state determination unit 413, an importance degree determination unit 414, a measurement data narrowing unit 415, a steady state determination model 416, a high-reliability transmission unit 417, and a low-reliability transmission unit 418. Of these units, the measurement data storage buffer 411, the steady state determination unit 413, the importance degree determination unit 414, the measurement data narrowing unit 415 and the steady state determination model 416 have the same functions as the measurement data storage buffer 211, the steady state determination unit 213, the importance degree determination unit 214, the measurement data narrowing unit 215 and the steady state determination model 216 shown in FIG. 4.

The high-reliability transmission unit 417 transmits measurement data by using a highly reliable communication protocol like TCP and stores the measurement data into the redundant recording device 421. The low-reliability transmission unit 418 transmits measurement data by using a communication protocol having relatively low reliability like UDP and stores the measurement data into the non-redundant recording device 422.

The redundant recording device 421 prepares for loss of data by putting a plurality of storages together and retaining data after replicating. The non-redundant recording device 422 does not replicate data. The non-redundant recording device 422 does not put a plurality of storages together or replicate data, thereby increasing a data access performance.

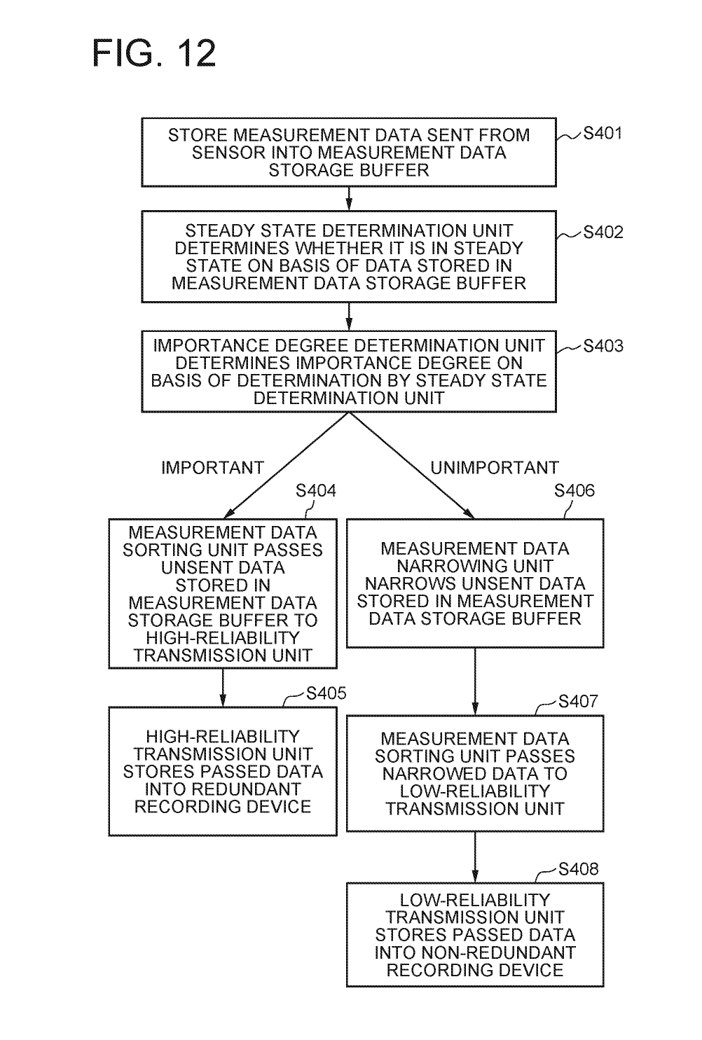

FIG. 12 is a flowchart showing an example of an operation of this exemplary embodiment. In FIG. 12, steps S401 to S403 are the same as steps S201 to S202 in FIG. 5. In this exemplary embodiment, in a case where the importance degree determination unit 414 does not determine as important, the measurement data narrowing unit 415 narrows unsent data stored in the measurement data storage buffer 411 (step S406), and passes the narrowed data to the low-reliability transmission unit 418 (step S407). The low-reliability transmission unit 418 stores the passed data into the non-redundant recording device 422 (step S408).

On the other hand, in a case where the importance degree determination unit 414 determines as important, the measurement data sorting unit 412 passes unsent data stored in the measurement data storage buffer 411 to the high-reliability transmission unit 417 (step S404). The high-reliability transmission unit 417 stores the passed data into the redundant recording device 421 (step S405).

As described above, the measurement data sorting unit 412 transmits measurement data determined as important by the importance degree determination unit 414 through the high-reliability transmission unit 417, and transmits the other data through the low-reliability transmission unit. In general, data can be more efficiently transmitted by using a low-reliability communication protocol like UDP than a high-reliability communication protocol like TCP. Moreover, a storage which does not replicate like the non-redundant recording device 422 is better in throughput and cost per capacity than a storage which replicates like the redundant recording device 421.

Thus, in this exemplary embodiment, a communication protocol and the reliability of a storage are changed depending on the degree of importance of data. Consequently, it is possible to avoid thinning out important measurement data and store the measurement data into the storage by using a reliable communication protocol and, on the other hand, it is possible to communicate and store unimportant measurement data at lower costs.

### Fifth Exemplary Embodiment

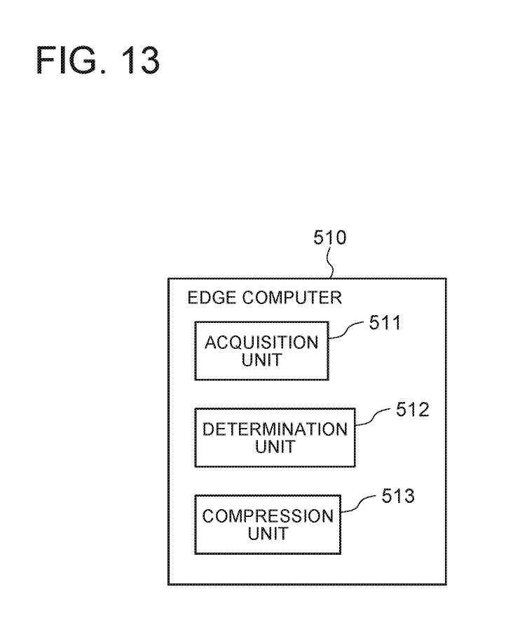

FIG. 13 is a block diagram of an edge computer 510 according to a fifth exemplary embodiment of the present invention. The edge computer 510 includes an acquisition unit 511, a determination unit 512, and a compression unit 513.

The acquisition unit 511 has a function to acquire plural types of measurement data. The acquisition unit 511 can be realized by, for example, the acquisition unit 111 shown in FIG. 1, but it not limited to that.

The determination unit 512 has a function to determine whether or not dependencies between plural types of measurement data acquired by the acquisition unit 511 match dependencies established between types of measurement data in the normal state (reference dependencies). The determination unit 512 can be realized by, for example, the determination unit 112 shown in FIG. 1, but is not limited to that.

The compression unit 513 has a function to compress measurement data acquired by the acquisition unit 511 on the basis of the result of determination by the determination unit 512. The compression unit 513 can be realized by, for example, the compression unit 113 shown in FIG. 1, but is not limited to that.

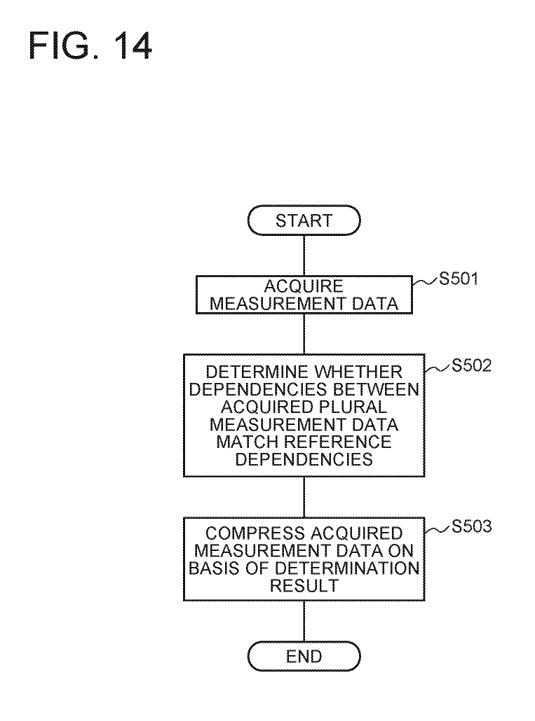

FIG. 14 is a flowchart showing an example of an operation of the edge computer 510. With reference to FIG. 14, firstly, the acquisition unit 511 acquires plural types of measurement data from a plurality of sensors which are not shown in the drawings (step S501). Next, the determination unit 512 determines whether or not dependencies between the plural types of measurement data acquired by the acquisition unit 511 match the reference dependencies (steps S502). Next, the compression unit 513 compresses the measurement data acquired by the acquisition unit 511 on the basis of the result of the determination by the determination unit 512 (step S503).

Thus, according to this exemplary embodiment, it is possible to effectively reduce the amount of measurement data without missing measurement data important for abnormality determination. This is because, on the basis of whether or not dependencies between plural types of measurement data having been acquired match dependencies established between types of measurement data in the normal state (reference dependencies), the acquired measurement data are compressed.

Although the present invention has been described above with the use of the exemplary embodiments, the present invention is not limited to the exemplary embodiments, and various kinds of additions and changes are possible within the scope of the present invention.

The present invention can be applied to a system such as a scientific experiment facility including a central server (a data store), an edge computer and a sensor, a vehicular system, a system which stores vehicular data, and the like.

The whole or part of the exemplary embodiments disclosed above can be described as, but not limited to, the following supplementary notes.

[Supplementary Note 1]

A measurement data processing method comprising:

performing acquisition of plural types of measurement data;

performing determination whether dependencies between the acquired measurement data match normal dependencies which are dependencies established between the measurement data in a normal state; and

performing compression of the acquired measurement data on a basis of a result of the determination.

[Supplementary Note 2]

The measurement data processing method according to Supplementary Note 1, wherein in the determination, the acquired measurement data are divided into important data and unimportant data on a basis of a result of the determination.

[Supplementary Note 3]

The measurement data processing method according to Supplementary Note 1 or 2, wherein in the determination, the acquired measurement data are divided so that the measurement data not matching the normal dependencies and the measurement data acquired within a predetermined time period from measurement time of the measurement data not matching the normal dependencies are regarded as important data and the measurement data other than the important data are regarded as unimportant data.

[Supplementary Note 4]

The measurement data processing method according to Supplementary Note 2 or 3, wherein in the compression, only the unimportant data are compressed or the unimportant data are compressed at a higher compression ratio than the important data.

[Supplementary Note 5]

The measurement data processing method according to Supplementary Note 2 or 3, wherein in the compression, the important data are not compressed at all or the important data are compressed at a lower compression ratio than the unimportant data.

[Supplementary Note 6]

The measurement data processing method according to Supplementary Note 2 or 3, wherein the acquisition, the determination and the compression are executed by an edge computer connected with plural types of sensors.

[Supplementary Note 7]

The measurement data processing method according to Supplementary Note 6, comprising performing transmission of the important data and the unimportant data from the edge computer to a server apparatus via a network.

[Supplementary Note 8]

The measurement data processing method according to Supplementary Note 7, wherein in the transmission, used communication protocols are different between the important data and the unimportant data.

[Supplementary Note 9]

The measurement data processing method according to Supplementary Note 7, wherein in the transmission, timings to transmit the important data and the unimportant data are controlled so that a delay time between the acquisition and the transmission is shorter in a case of the important data than in a case of the unimportant data.

[Supplementary Note 10]

The measurement data processing method according to Supplementary Note 7, wherein in the server apparatus, the important data received from the edge computer are stored into a more reliable storage device than a storage device for storing the unimportant data received from the edge computer.

[Supplementary Note 11]

The measurement data processing method according to Supplementary Note 7, wherein in the server apparatus, an analysis of presence/absence of an abnormality is performed on a basis of the measurement data received from the edge computer and, in the analysis, an analysis result that an abnormality has not occurred at acquisition time of the measurement data included by the unimportant data is generated.

[Supplementary Note 12]

An edge computer comprising:

an acquisition unit configured to perform acquisition of plural types of measurement data;

a determination unit configured to perform determination whether dependencies between the acquired measurement data match dependencies established between the measurement data in a normal state; and

a compression unit configured to perform compression of the acquired measurement data on a basis of a result of the determination.

[Supplementary Note 13]

The edge computer according to Supplementary Note 12, wherein the determination unit is configured to divide the acquired measurement data into important data and unimportant data on a basis of a result of the determination.

[Supplementary Note 14]

The edge computer according to Supplementary Note 12 or 13, wherein the determination unit is configured to divide the acquired measurement data so that the measurement data not matching the normal dependencies and the measurement data acquired within a predetermined time period from measurement time of the measurement data not matching the normal dependencies are regarded as important data and the measurement data other than the important data are regarded as unimportant data.

[Supplementary Note 15]

The edge computer according to Supplementary Note 13 or 14, wherein the compression unit is configured to compress only the unimportant data or compress the unimportant data at a higher compression ratio than the important data.

[Supplementary Note 16]

The edge computer according to Supplementary Note 13 or 14, wherein the compression unit is configured to not compress the important data at all or to compress the important data at a lower compression ratio than the unimportant data.

[Supplementary Note 17]

The edge computer according to any of Supplementary Notes 13 to 16, further comprising a communication unit configured to transmit the important data and the unimportant data to a server apparatus via a network.

[Supplementary Note 18]

The edge computer according to Supplementary Note 17, wherein the communication unit is configured to use different communication protocols between the important data and the unimportant data.

[Supplementary Note 19]

The edge computer according to Supplementary Note 17, wherein the communication unit is configured to control timings to transmit the important data and the unimportant data so that a delay time between the acquisition and the transmission is shorter in a case of the important data than in a case of the unimportant data.

[Supplementary Note 20]

The edge computer according to Supplementary Note 17, wherein the communication unit is configured to transmit the unimportant data to store the unimportant data into a first storage device of the server apparatus and transmit the important data to store the important data into a second storage device of the server apparatus, the second storage device being more reliable than the first storage device.

[Supplementary Note 21]

A computer program comprising instructions for causing a computer to function as:

an acquisition unit configured to perform acquisition of plural types of measurement data;

a determination unit configured to perform determination whether dependencies between the acquired measurement data match dependencies established between the measurement data in a normal state; and

a compression unit configured to perform compression of the acquired measurement data on a basis of a result of the determination.

[Supplementary Note 22]

A measurement data processing system comprising:

an edge computer according to any one of Supplementary Notes 12 to 20;

a device having a sensor connected to the edge computer; and

a server apparatus connected to the edge computer.

### DESCRIPTION OF REFERENCE NUMERALS

100 measurement data processing system
110-1 to 110-n edge computer
111-1 to 111-n acquisition unit
112-1 to 112-n determination unit
113-1 to 113-n compression unit
114-1 to 114-n communication unit
120 server apparatus
121 communication unit
122 storage unit
123 analysis unit
124 output unit
130-11 to 130-nm device
140 network
150-11 to 150-nm sensor
180 information processing apparatus
181 arithmetic processing part
182 storage part
183 first communication module
184 second communication module
185 program
190 information processing apparatus
191 arithmetic processing part
192 storage part
193 communication module
194 output part
195 program
210 edge computer
211 measurement data storage buffer
212 measurement data transmission unit
213 steady state determination unit
214 importance degree determination unit
215 measurement data narrowing unit
216 steady state determination model
220 cloud
221 measurement data recording device
230 measurement data occurrence unit
310 edge computer
311 measurement data storage buffer
312 measurement data transmission unit
313 steady state determination unit
314 importance degree determination unit
315 high-compression-ratio data compression unit
316 steady state determination model
317 transmission timing control unit
320 cloud
321 measurement data recording device
330 measurement data occurrence unit
410 edge computer
411 measurement data storage buffer
412 measurement data sorting unit
413 steady state determination unit
414 importance degree determination unit
415 measurement data narrowing unit
416 steady state determination model
417 high-reliability transmission unit
418 low-reliability transmission unit
420 cloud
421 redundant recording device
422 non-redundant recording device
430 measurement data occurrence unit
510 edge computer
511 acquisition unit
512 determination unit
513 compression unit

1. An edge computer connected to plural types of sensors each measuring a status of a monitoring target and also connected to a server apparatus, the edge computer comprising:
an acquisition unit configured to regularly acquire a data set including a plurality of measurement data measured by the plural types of sensors;
a determination unit configured to previously hold dependencies between the measurement data measured by the plural types of sensors when the monitoring target is normal as reference dependencies and, every time the data set is acquired, perform determination whether or not dependencies between the measurement data included by the data set match the reference dependencies; and
a compression unit configured to perform compression of the data set to transmit the data set to the server apparatus on a basis of a result of the determination.

2. The edge computer according to claim 1, wherein the determination unit is configured to classify a plurality of data sets acquired by the acquisition unit into important data and unimportant data, the important data including the data set determined as not matching the reference dependencies, and the unimportant data not including the data set determined as not matching the reference dependencies.

3. The edge computer according to claim 2, wherein the compression unit is configured to compress only the unimportant data or compress the unimportant data at a higher compression ratio than the important data.

4. The edge computer according to claim 2, wherein the compression unit is configured to not compress the important data at all or to compress the important data at a lower compression ratio that the unimportant ratio

5. The edge computer according to claim 1, further comprising a communication unit configured to transmit the important data and the unimportant data to the server apparatus by using different communication protocols between the important data and the unimportant data.

6. The edge computer according to claim 1, further comprising a communication unit configured to transmit the important data and the unimportant data to the server apparatus while controlling timings to transmit the important data and the unimportant data so that a delay time between acquisition from the sensor devices and transmission is shorter in a case of the important data than in a case of the unimportant data.

7. The edge computer according to claim 1, further comprising a communication unit configured to transmit the unimportant data to store the unimportant data into a first storage device of the server apparatus and transmit the important data to store the important data into a second storage device of the server apparatus, the second storage device being more reliable than the first storage device.

8. A measurement data processing method executed by an edge computer connected to plural types of sensors each measuring a status of a monitoring target and also connected to a server apparatus, the measurement data processing method comprising:
regularly acquiring a data set including a plurality of measurement data measured by the plural types of sensors;
previously holding dependencies between the measurement data measured by the plural types of sensors when the monitoring target is normal as reference dependencies and, every time the data set is acquired, performing determination whether or not dependencies between the measurement data included by the data set match the reference dependencies; and
performing compression of the data set to transmit the data set to the server apparatus on a basis of a result of the determination.

9. The measurement data processing method according to claim 8, wherein in the determination, a plurality of data sets acquired are classified into important data and unimportant data, the important data including the data set determined as not matching the reference dependencies, and the unimportant data not including the data set determined as not matching the reference dependencies.

10. The measurement data processing method according to claim 9, wherein in the compression, only the unimportant data are compressed or the unimportant data are compressed at a higher compression ratio than the important data.

11. The measurement data processing method according to claim 9, wherein in the compression, the important data are not compressed at all or the important data are compressed at a lower compression ratio that the unimportant ratio

12. The measurement data processing method according to claim 8, further comprising transmitting the important data and the unimportant data to the server apparatus by using different communication protocols between the important data and the unimportant data.

13. The measurement data processing method according to claim 8, further comprising transmitting the important data and the unimportant data to the server apparatus while controlling timings to transmit the important data and the unimportant data so that a delay time between acquisition from the sensor devices and transmission is shorter in a case of the important data than in a case of the unimportant data.

14. The measurement data processing method according to claim 8, further comprising transmitting the unimportant data to store the unimportant data into a first storage device of the server apparatus and transmitting the important data to store the important data into a second storage device of the server apparatus, the second storage device being more reliable than the first storage device.

15. A non-transitory computer-readable medium storing a program comprising instructions for causing a computer, which is connected to plural types of sensors each measuring a status of a monitoring target and also connected to a server apparatus, to function as:
an acquisition unit configured to regularly acquire a data set including a plurality of measurement data measured by the plural types of sensors;
a determination unit configured to previously hold dependencies between the measurement data measured by the plural types of sensors when the monitoring target is normal as reference dependencies and, every time the data set is acquired, perform determination whether or not dependencies between the measurement data included by the data set match the reference dependencies; and
a compression unit configured to perform compression of the data set to transmit the data set to the server apparatus on a basis of a result of the determination.
